(19) United States
(12) Patent Application Publication
(10) Pub. No.: US 2012/0242167 A1
(43) Pub. Date: Sep. 27, 2012

(54) Method for Logically Disconnecting a USB Device from a Host without Mechanical Disconnection

(75) Inventors: Ping-Shun Zeung, New Taipei City (TW); Musa Ibrahim Kakish, Santa Ana, CA (US)

(73) Assignee: I/O Interconnect, Ltd.

(21) Appl. No.: 13/164,735

(22) Filed: Jun. 20, 2011

Related U.S. Application Data
(60) Provisional application No. 61/467,398, filed on Mar. 25, 2011.

(51) Int. Cl. H01H 47/00

(52) U.S. Cl. 307/112

(57) ABSTRACT

The method disposes a power-swicthable USB port in a host, which is connected to a USB device. The relay has a control pin controlled by the host and two switch pins electrically connected between a power pin of the USB port and a power source of the host. The host sends a control signal to the control pin of the relay to close the switch pins when the USB port is held normal by a user. The host sends another control signal to the control pin to open the switch pins and cut off the power to the USB port when the user is logically disconnecting the USB device from the host.

This application claims the benefit of U.S. Provisional Application No. 61/467,398, filed Mar. 25, 2011.

### BACKGROUND OF THE INVENTION

1. Technical Field

The invention relates connection between a USB device and a host computer, particularly to a method for logically disconnecting the USB device from the host computer.

2. Related Art

In an aspect of substantial technology, a smart phone is equivalent to a handheld computer with a cellular phone and a digital camera. Thus, smart phones must be installed with operating systems (“OSes”) such as Android®, Symbian® and Windows Phone®. Android has a large community of developers writing applications (“apps”) that extend the functionality of the devices. There are currently over 150,000 apps available for Android. Thus Android occupies a high market share for smart phones.

Smart phones can be electrically connected to personal computers (PCs) for data access or management. When an Android-based smart phone is connected to a PC via a universal serial bus (USB) cable, it will become a mass storage device of the PC. That is to say, the smart phone is under the dominion of the PC when they have made an operative connection. Memory of a smart phone is usually composed of a built-in memory and a memory card. The data stored in the memory card can be accessed through the OS (Android) of the smart phone when the smart phone has not connected to a PC yet. The memory card, however, will be accessed only through the PC once the smart phone is connected to a PC. In other words, a smart phone loses its mastership over the memory card while it is connecting to a PC. This will be a problem because some apps for Android may require that a memory card in an Android-based smart phone can be accessed through the OS (Android) thereof while the smart phone is connecting to a PC. These apps cannot work if the PC does not release its mastership over a memory card in an Android-based smart phone. In other words, the PC connecting with the smart phone must temporarily release its mastership over the smart phone to have the smart phone autonomously operatable.

However, the PC will release its mastership over the smart phone connected thereto only by mechanically removing the USB cable therebetween. The PC still do not really release its mastership over the smart phone if a user only operates an OS of the PC to “eject” the smart phone without removing the USB cable. Every time a user wants to temporarily independently operate the smart phone connected to the PC, he or she always has to remove the cable therebetween once and again. This is inconvenient for users and easy to cause poor contact between connectors.

### SUMMARY OF THE INVENTION

An object of the invention is to provide a user an option of forcing a PC to release its mastership over a USB device which is being connected to the PC. The USB device can restore its own mastership over its peripheral I/O devices when the USB device is still connecting to the PC. This may render a USB device autonomously operatable and accessible during an interconnection with a PC via a USB cable.

To accomplish the above object, the method of the invention disposes a power-swicthable USB port in a host, which is connected to a USB device. The relay has a control pin controlled by the host and two switch pins electrically connected between a power pin of the USB port and a power source of the host. The host sends a control signal to the control pin of the relay to close the switch pins when the USB port is held normal by a user. The host sends another control signal to the control pin to open the switch pins and cut off the power to the USB port when the user is logically disconnecting the USB device from the host. No method could logically disconnect the USB device from the PC without mechanically operation.

### BRIEF DESCRIPTION OF THE DRAWINGS

FIG. 1 is a schematic diagram of hardware arrangement of the invention; and

FIG. 2 is a flowchart of the method of the invention.

### DETAILED DESCRIPTION OF THE INVENTION

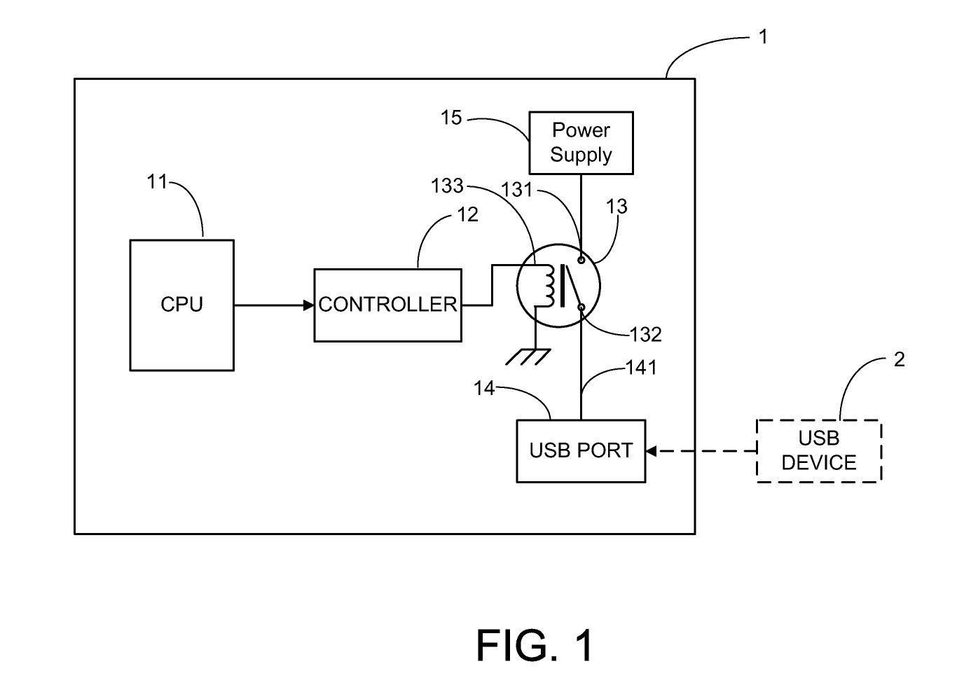

Please refer to FIG. 1. The invention provides a method for logically disconnecting a USB (universal serial bus) device 2, such as a smart phone, from a host 1. Inherently, the host 1 includes a CPU 11, a USB port 14, a power supply 15 and several peripheral controllers such as a card reader controller, network controller, keyboard and mouse controller, etc. However, for the sake of simplification, only one controller 12 is shown in the drawing. Preferably, this controller 12 is a card reader controller. The peripheral controller 12 is commanded by the CPU 11.

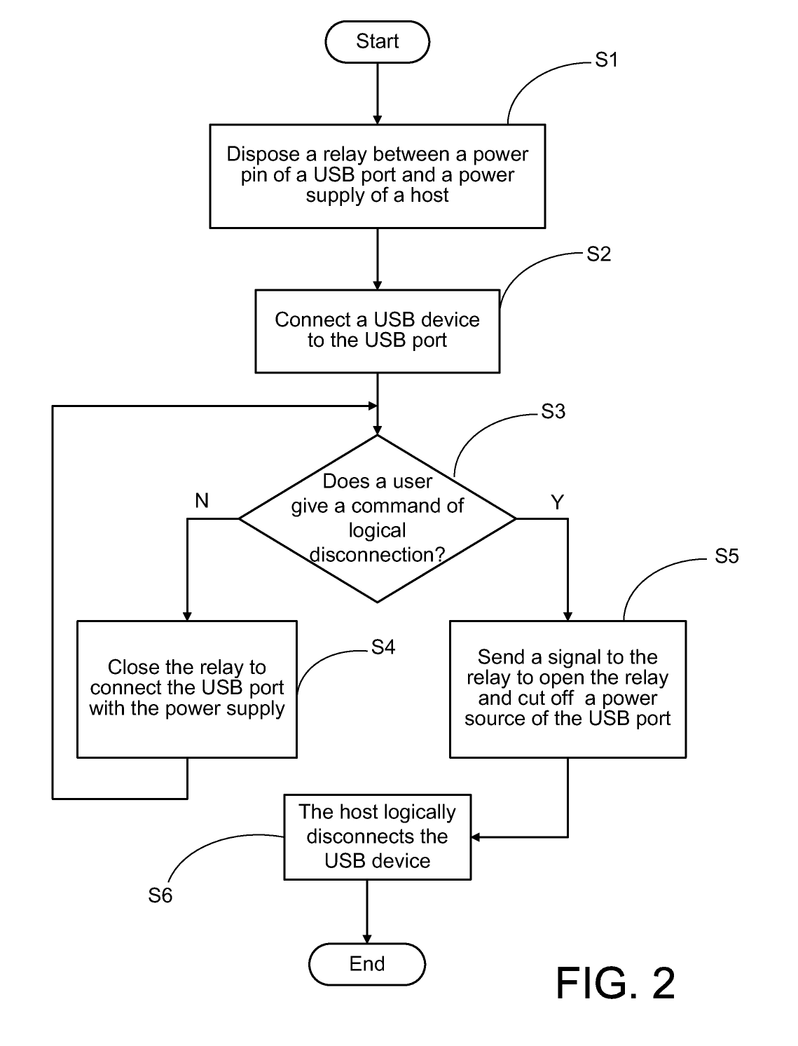

Please refer to FIG. 2. Firstly, in step S1, the method disposes a relay 13 between the power supply 15 and the USB port 14 of the host 1. According to the standard specification of the USB, the USB port 14 has a power pin 141 connecting to the power supply 15 for providing electric power of DC 5V. The power pin 141 of the USB port 14 is connected to two switch contacts 131, 132 of the relay 13 to make it switchable. Preferably, the relay 13 is of a normally-closed (NC) type for keeping the power pin 141 normally connecting to the power supply 15. There is a control pin 133 on the relay 13 for controlling the switch contacts 131, 132 to act. The control pin 133 electrically connects to the controller 12.

The USB device 2 is connected to the USB port 14 via a USB cable (not shown) in step S2. The switch contacts 131, 132 of the relay 13 keep closed to connect the power pin 141 with the power supply 15 when a user is not disconnecting the USB device 2 from the host 1 in steps S3 and S4. In other words, the USB port 14 functions normally if a command of logical disconnection is not given by a user. The CPU 11 will send a control signal to the peripheral controller 12 when a user operates a specific application program run by the CPU 1 to release a mastership of the host 1 over the USB device 2 or to logically disconnect the USB device 2 from the host 1, and then the peripheral controller 12 sends a trigger signal to the relay 13 to open or disconnect the switch contacts 131, 132 thereof, in steps S3 and S5. As a result, the DC 5V power of the USB port 14 is cut off.

Once the DC power is removed from the USB port 14, the CPU 11 will incorrectly but user-expectantly assume the USB device 2 to have been removed from the USB port 14, i.e. logical disconnection. Accordingly, the host 1 will release its mastership over the USB device 2 and the USB device 2 becomes autonomously operatable and accessible without materially removing the USB device 2 from the USB port 14 in step S6.

It will be appreciated by persons skilled in the art that the above embodiment has been described by way of example only and not in any limitative sense, and that various alterations and modifications are possible without departure from the scope of the invention as defined by the appended claims. It will be appreciated by persons skilled in the art that the above embodiment has been described by way of example only and not in any limitative sense, and that various alterations and modifications are possible without departure from the scope of the invention as defined by the appended claims.

What is claimed is:

1. A method for logically disconnecting a universal serial bus (USB) device from a host, comprising the steps of:
a) disposing a relay between a power pin of a USB port of the host and a power supply of the host;
b) connecting the USB device to the USB port;
c) making the switch contacts closed to keep the USB port normal if no command of disconnection is given; and
d) sending a control signal to the control pin of the relay to open the switch contacts and cut off power from the power supply to the power pin if a command of disconnection is given.

2. The method of claim 1, wherein the control signal is sent from a central processing unit (CPU) of the host to the relay through a peripheral controller.

3. The method of claim 2, wherein the peripheral controller is a card reader controller.

4. The method of claim 1, wherein the relay is of a normally-closed type.

5. The method of claim 1, wherein the relay has a control pin controlled by the host and two switch contacts electrically connected between the power pin of the USB port and the power supply.

6. A method for logically disconnecting a universal serial bus (USB) device from a host having a USB port, comprising the steps of:
a) making the USB port power-switchable;
b) connecting the USB device to the USB port;
c) switching on power of the USB port if no command of disconnection is given; and
d) switching off power of the USB port if a command of disconnection is given.

7. The method of claim 6, wherein the step a) is performed by disposing a relay between a power pin of the USB port and a power supply of the host.

8. The method of claim 7, wherein the relay is of a normally-closed type.
